(19) United States
(12) Patent Application Publication
(10) Pub. No.: US 2006/0229772 A1
(43) Pub. Date: Oct. 12, 2006

(54) Systems and methods for avionics software delivery

(75) Inventor: Charles R. McClary, Spring Lake Park, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/101,897

(22) Filed: Apr. 8, 2005

(51) Int. Cl. G01C 23/00

(52) U.S. Cl. 701/3

(57) ABSTRACT

Systems and methods delivering avionics software are disclosed. One method comprises equipping one or more aircraft with a computer hardware unit adapted to implement time and memory space partitioning of one or more software applications; assigning a hardware part number to the computer hardware unit; installing one or more software applications into a memory of the computer hardware unit using one or more integrity verification protocols, wherein one or more features of the one or more software applications are enabled; and assigning a software part number to a software application of the one or more software applications based on the one or more features of the one or more software applications that are enabled.

### TECHNICAL FIELD

The present invention generally relates to aircraft and more specifically to the delivery of avionics software.

### BACKGROUND

Typically in the avionics industry, a unit of hardware containing embedded software is treated as a single device and designated by a single part number. For hardware units used in safety critical applications (e.g. applications with the potential to affect the safe flight of an aircraft), the part number of the hardware unit identifies whether the hardware unit is certified for use in a particular aircraft. In the past, if a software bug required fixing or an aircraft operator desired to add a new feature, the aircraft operator had to remove the hardware unit out of the aircraft, deliver the hardware unit to a service vendor, remove the sub-component (usually a card mounted device) storing the software from the hardware unit, update the software resident on the sub-component, reinstall the sub-component into the hardware unit, test the hardware unit, and reinstall the hardware unit to the aircraft. The updated hardware unit would then be assigned a new part number in order to differentiate it from non-upgraded hardware units. Technological changes in the avionics industry provide an opportunity for improved system and methods for delivering avionics software and provide the ability for aircraft systems manufactures to better customize avionics hardware to meet the needs of customers while creating economic opportunities for aircraft systems manufactures.

For the reasons stated above and for other reasons stated below which will become apparent to those skilled in the art upon reading and understanding the specification, there is a need in the art for improved methods and systems for delivering avionics software.

### SUMMARY

The Embodiments of the present invention provide improved methods and systems for delivering avionics software and will be understood by reading and studying the following specification.

In one embodiment, a software application for an on-aircraft computing system, wherein the computing system is adapted to execute one or more time and memory space partitioned software applications, is provided. The software application comprises a plurality of features, wherein one or more of the plurality of features are disabled until a software key is provided to the computing system. The software application further comprises a software part number, wherein the software part number identifies which of the plurality of features are enabled.

In another embodiment, a system for delivering on-aircraft avionics software applications is provided. The system comprises a computing system, wherein the computing system is adapted to execute one or more software applications, wherein each software application is time and memory space partitioned, wherein each software application includes one or more features. The system further comprises one or more memories adapted to store the one or more software applications; one or more delivery medium adapted to store a software code including one or more of a software application, a software upgrade for the one or more software applications, and a software key; and one or more on-aircraft data transfer systems adapted to receive the software code from the one or more delivery systems and store the software code in the one or more memories. When the software code includes one or both of a software application and a software upgrade for the one or more software applications, the computing system and the data transfer system are further adapted to implement one or more integrity verification protocols to verify that the software code is loaded into the one or more memories correctly. When the software code is a software key, the computing system is further adapted to enable one or more features of the one or more software applications. Each software application includes a software part number that identifies enabled features of the software application and software upgrades made to the software application.

In yet another embodiment, a method for delivering avionics software is provided. The method comprises equipping one or more aircraft with a computer hardware unit adapted to implement time and memory space partitioning of one or more software applications; assigning a hardware part number to the computer hardware unit; installing one or more software applications into a memory of the computer hardware unit using one or more integrity verification protocols, wherein one or more features of the one or more software applications are enabled; and assigning a software part number to a software application of the one or more software applications based on the one or more features of the one or more software applications that are enabled.

In still another embodiment, a system for delivering on-aircraft avionics software applications is provided. The system comprises means for executing one or more software applications, wherein each software application of the one or more software applications is time and memory space partitioned, wherein each software application of the one or more software applications includes one or more features. The system further comprises memory means adapted to store the one or more software applications; means for selectively enabling one or more of the one or more features of the one or more software applications, wherein each software application is adapted with a software part number that identifies the one or more enabled features; means for delivering software code, wherein the software code includes one or more of a software application, a software upgrade for the one or more software applications, and a software key; and means for receiving the software code, wherein the means for receiving the software code is adapted to implement one or more integrity verification protocols to verify that the software code is received correctly.

### DRAWINGS

The present invention is more easily understood and further advantages and uses thereof more readily apparent, when considered in view of the description of the preferred embodiments and the following figures in which:

FIG. 1 is a diagram illustrating a system for delivering software applications to an aircraft of one embodiment of the present invention; and

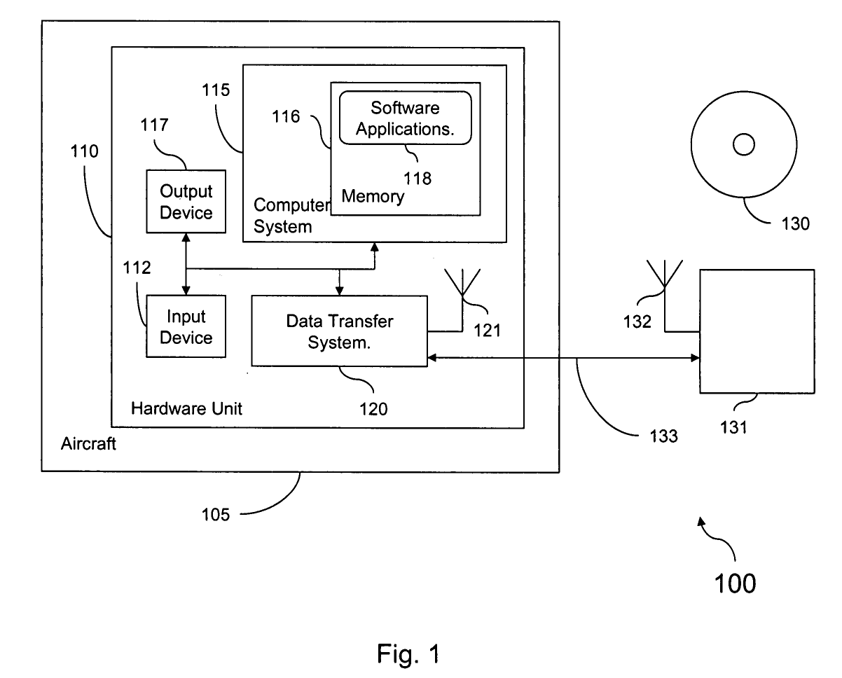

FIG. 2 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide methods and systems for delivering avionics software features to aircraft owners while obtaining financial compensation to equipment vendors for the value added by the use or enabling of various software features. Embodiments of the present invention comprise five facets which may be used alone or in various combinations.

The first facet of one embodiment 100 of the present invention comprises an aircraft 105 having a computerized hardware unit 110, including devices such as, but not limited to, a flight control system, an inertial navigation system or a central computing system. Hardware unit 110 comprises a computer system 115 which is adapted for time and memory space partitioning of software applications. Rather than performing a single aircraft function on a single computer, time and memory space partitioning of software applications allows multiple functions, potentially of different criticality significance, to be performed by a single computer system 115. In one embodiment, functions performed by hardware unit 110 include one or more of, but not limited to, navigation, flight path calculations, flight control, fuel consumption calculations, and communications. Time and memory space partitioning of software applications on hardware unit 110 guarantees that one software application 118 will not corrupt the memory or execution space of any other software application 118. Such guarantees are important when multiple aircraft functions, especially flight critical functions, are performed by a single computing system. As used in this application, the term computing system includes those elements of an overall system that perform processing or computational functions for the overall system. In one embodiment, hardware unit 110 further comprises one or more memory units 116 adapted to store executable program code for the one or more of the software applications 118.

The second facet of the present invention comprises an on-aircraft data transfer system 120 adapted for loading software applications 118 into hardware unit 110 without the need to remove hardware unit 110 from aircraft 105. In one embodiment, data transfer system 120 comprises one or more of, but not limited to, a magnetic tape drive, a magnetic media disk drive, an optical disk drive, a serial data port, an Ethernet port, an optical media or coaxial interface, a wireless data transceiver, or other data transfer interface capable of transferring software code into memory units 116 of hardware unit 110. In one embodiment data transfer system 120 is further adapted to implement one or more standard protocols to verify that software loaded into aircraft 105 is loaded correctly. In one embodiment, data transfer system 120 is adapted to implement Aeronautical Radio, Incorporated (ARINC) integrity verification protocol ARNIC 615. It is understood in the industry that for high integrity applications, such a those whose failure might cause the interruption of the safe flight of an aircraft, implementing at least two diverse integrity verification protocols is recommended.

The third facet of the present invention comprises a delivery medium to store computer executable program code for hardware unit 110, adapted for use with data transfer system 120. In one embodiment, a delivery medium 130 comprises computer readable media including, but not limited to, punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. In another embodiment, a delivery medium 131 is adapted to communicate with data transfer system 120 and transmit program code for hardware unit 110, via communication link 133. In one embodiment, communication link 133 comprises a serial data cable, an Ethernet cable, fiber optic media or coaxial media, or other communication media. In one embodiment, data transfer system 120 and delivery medium 131 are further adapted, respectively, with antennas 121 and 132. In one embodiment data transfer system 120 and embodiment delivery medium 131 communicate and transmit program code for hardware unit via a wireless communication link.

The fourth facet of the present invention includes enabling and disabling of features of the one or more software applications 118 resident on hardware unit 110. In one embodiment, the one or more software applications 118 are capable of performing multiple functions through one or more enabled features. In one embodiment, hardware unit 110 is adapted to enable or disable individual features of software applications 118 based on whether or not access to those features has been purchased by the operator of aircraft 105. For example, hardware unit 110 may be initially installed into aircraft 105 with software applications 118 having a baseline set of features enabled. In one embodiment, the purchaser of hardware unit 110 pays a purchase price which reflects which specific features of software applications 118 are initially enabled. In one embodiment, when the owner of hardware 105 desires to have one or more initially disabled features of software applications 118 enabled, the owner purchases access to the desired features. In one embodiment, the purchaser is provided a key to unlock one or more features associated with the key. In one embodiment, the key is a password entered into an input device 112, such as, but not limited to, a keypad, pointing device, touch screen, or similar input device. In one embodiment, the key is a software key provided to the purchaser either on a delivery medium 130 or 131 in which the purchaser loads into hardware unit 110 via data transfer system 120. Once hardware unit 110 receives the key, the associated features of software application 118 are enabled.

In one embodiment, hardware unit 110 is provided with new or updated functions, by updating or replacing one or more of software applications 118. New functions may include one or more of, but not limited to, inertial navigation systems, flight path calculations, flight control functions, fuel consumption calculations, satellite navigation, aircraft and communications functions that were previously unavailable on hardware unit 110. In one embodiment, updating a function may include correcting a bug in an algorithm that implements the function. In one embodiment, updating a function may include adding one or more additional features.

As one example of adding additional features, in one embodiment, hardware unit 110 may initially calculate fuel consumption rates based on one or more numerical constants pre-loaded into memory 116. In one embodiment of the present invention, the fuel consumption rate calculation function is upgraded with the ability to calculate fuel consumption rates based on an algorithm rather than the numerical constants. In one embodiment, the fuel consumption rate calculation function can be further upgraded with the ability to calculate fuel consumption rates based on dynamic data provided by other flight systems, or other software applications 118. In one embodiment, the software code for all three of the above fuel calculation features is resident in hardware unit 110, but only the first (i.e. the baseline) feature is enabled while the later two features are initially disabled. In one embodiment, one are both of the later two features are subsequently unlocked only after the owner decides to purchase the key for the additional features.

In one embodiment, software code providing new or updated features for software applications 118 is not initially resident on hardware unit 110 but is provided to the purchaser via delivery mediums 130 or 131. The purchaser loads software code for the new of updated features into hardware unit 110 via data transfer system 120. In one embodiment, the software code provides additional features to hardware unit 110 by altering or replacing existing software code in memory units 116 (e.g. the software code provides a patch to the existing software applications 118.) With embodiments of the present invention, the owner of aircraft 105 can thusly replace existing software applications with updated software applications. In one embodiment, the software code provides additional features to hardware unit 110 by adding one or more additional software applications into memory units 116. As discussed above, in one embodiment, data transfer system 120 implements one or integrity verification protocols to verify that the software code loaded into memory units 116 correctly.

The fifth facet of the present invention includes the separation of hardware and software part numbers. In the United States, aircraft manufactures certify hardware devices for use in aircraft, based on FAA regulations. Whether a certain hardware device is certified for use in a certain aircraft is determined by referencing the part number of the device. Embodiments of the present invention comprise separate software part numbers for software applications 118 that identify which specific features of software applications 118 are enabled on hardware unit 110. In one embodiment, when additional features are enabled, or when software code in memory units 116 is altered, the software part number for the affected software application of software applications 118 is updated to reflect the change. In one embodiment, the manufacturer of aircraft 105 determines whether hardware unit 110 is certified for use in aircraft 105 based on both the hardware part number for hardware unit 110, and the software part numbers of software applications 118. In one embodiment, the hardware part number for hardware unit 110 is located on a nameplate affixed to hardware unit 110. In one embodiment, the software part numbers of software applications 118 can be determined by interrogating hardware unit 110 via input device 112, which then provides the part number via an output device 117, such as a video display terminal, a printer, or similar output device. As used in this application, the term “part number” includes any string of one or more alpha-numeric characters, or any other symbols used in any code or method of marks which may be used to separately identify software applications based on different characteristics of the software applications.

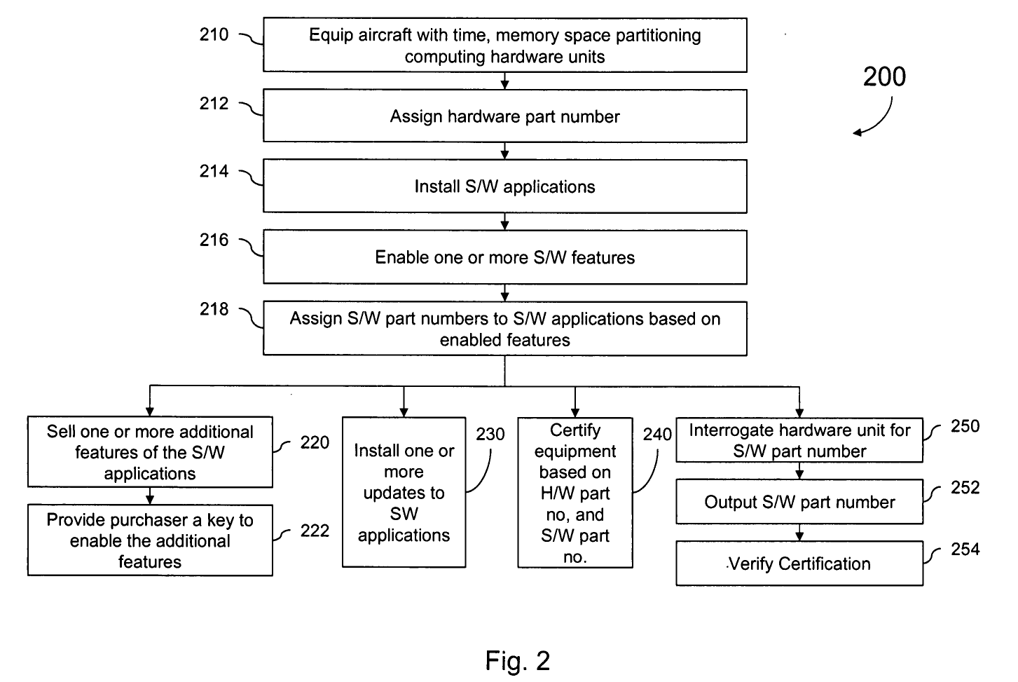

FIG. 2 is a flow chart illustrating a method 200 for delivering avionics software to a hardware unit installed in an aircraft. One or more aircraft are equipped with at least one computer hardware unit adapted to implement time and memory space partitioning of one or more software applications (block 210). In one embodiment, functions performed by the computer hardware unit include one or more of, but not limited to, navigation, flight path calculations, flight control, fuel consumption calculations, and communications. A hardware part number is assigned to the computer hardware unit (block 212) which may be used to identify important hardware characteristics, such the specific hardware components that comprise the computer hardware unit. One or more software applications are installed into a memory of the computer hardware unit using one or more integrity verification protocols (block 214). Integrity verification protocols, such as ARNIC 615, ensure that software is loaded into the memory of the computer hardware unit correctly. Initially, one or more features of the one or more software applications are enabled (block 216), which establishes the baseline functionality of the computer hardware unit. Which features are initially enabled in the computer hardware unit is based on an initial purchase price paid by the purchaser of the hardware unit, which is in turn based on which features the purchaser desired to have enabled. This allows the purchaser to only pay for those features they desire and not pay for features they do not plan to use. A software part number is assigned to each software application of the one or more software applications based on which of the one or more features of the one or more software applications are enabled (block 218). This software part number for a particular software application will change if the software application is subsequently upgraded or if additional features are enabled, to reflect those changes to the software application.

When the owner of the aircraft wishes to add to, update, or otherwise enhance the functionality of the computer hardware unit, the owner may do so by purchasing upgrades. In one embodiment, where one or more features of the one or more software applications are resident in the computer hardware unit, but disabled, the method further comprises selling one or more additional features of the one or more software applications (block 220) to the owner of the hardware unit. The vendor provides the owner with a key to enable one or more features of the one or more software applications that were disabled (block 222). Selling keys that unlock additional features allows the vendor of the hardware unit to collect additional compensation (beyond the original purchase price) for the value of the additional features. At the same time, aircraft owners who do not initially desire the additional features need not pay for them when the computer hardware unit is initially purchased. In one embodiment, the key is a software key recorded or transmitted on a delivery medium and respectively loaded or received by a data transfer system. In another embodiment, the key is a code that the purchaser enters into the computer hardware unit with the assistance of a keypad, a mouse, a touch-screen, or other appropriate input device. Upon receiving the key, the computer hardware unit is enabled to perform new functions based on the features purchased. In another embodiment, the method further comprises installing one or more updates to the one or more software applications using one or more integrity verification protocols (block 230). In one embodiment, the software updates are recorded or transmitted on a delivery medium and respectively loaded or received by a data transfer system. This allows the vendor of a hardware unit to update the software code of the one or more software applications to ether correct bugs, or add additional features which may be enabled sometime in the future as described in blocks 220 and 222.

In another embodiment, the vendor of a hardware unit, or other entity authorized to certify systems for use in aircraft, certifies a hardware unit for use in aircraft based on the hardware part number of the hardware unit and the software part number for the one or more software applications (block 240). In one embodiment the hardware unit may itself be certified for use on a plurality of different aircraft, and specific features of software applications may be certified for use on a plurality of different aircraft. In one embodiment, the method further comprises interrogating the computer hardware unit (block 250) to request the software part number of one or more of the one or more software applications. In one embodiment, the computer hardware unit is interrogated by entering one or more commands with the assistance of a keypad, a mouse, a touch-screen, or other appropriate input device. The software part number of one or more of the one or more software applications is then provided as output via a video screen, printer, or other appropriate output device (block 252). The owner or operator of aircraft can then verify that the combination of computer hardware units and software applications installed on an aircraft are certified for use in that aircraft by referencing one or more documents. In one embodiment, such documentation may include, but are not limited to, vendor documentation comprising a cross-reference table that identifies hardware and software part number combinations that the vendor has certified for use with an aircraft (block 254).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A software application for an on-aircraft computing system, wherein the computing system is adapted to execute one or more time and memory space partitioned software applications, the software application comprising:
a plurality of features; wherein one or more of the plurality of features are disabled until a software key is provided to the computing system; and
a software part number, wherein the software part number identifies which of the plurality of features are enabled.

2. A system for delivering on-aircraft avionics software applications, the system comprising:
a computing system, wherein the computing system is adapted to execute one or more software applications, wherein each software application is time and memory space partitioned, wherein each software application includes one or more features;
one or more memories adapted to store the one or more software applications;
one or more delivery medium adapted to store a software code including one or more of a software application, a software upgrade for the one or more software applications, and a software key; and
one or more on-aircraft data transfer systems adapted to receive the software code from the one or more delivery systems and store the software code in the one or more memories;
wherein when the software code includes one or both of a software application and a software upgrade for the one or more software applications, the computing system and the data transfer system are further adapted to implement one or more integrity verification protocols to verify that the software code is loaded into the one or more memories correctly;
wherein when the software code is a software key, the computing system is further adapted to enable one or more features of the one or more software applications;
wherein each software application includes a software part number that identifies enabled features of the software application and software upgrades made to the software application.

3. The system of claim 2, wherein the one or more delivery medium further comprises one or more of punch cards, magnetic disk, magnetic tape, an optical disk, flash read only memory (ROM), non-volatile ROM, programmable ROM (PROM), erasable-programmable ROM (E-PROM), random access memory (RAM), electronic transmission via wire, a wireless communication link, and an optical cable.

4. The system of claim 2, wherein the computing system is further adapted to output the software part number of one or more of the one or more software applications.

5. The system of claim 2, wherein the one or more data transfer systems further comprises an input device, wherein when the software key is entered on the input device, the computing system is further adapted to enable one or more features of the one or more software applications.

6. The system of claim 2, wherein the one or more integrity verification protocols includes the ARNIC 615 protocol.

7. A method for delivering avionics software, the method comprising:
equipping one or more aircraft with a computer hardware unit adapted to implement time and memory space partitioning of one or more software applications;
assigning a hardware part number to the computer hardware unit;
installing one or more software applications into a memory of the computer hardware unit using one or more integrity verification protocols, wherein one or more features of the one or more software applications are enabled; and
assigning a software part number to a software application of the one or more software applications based on the one or more features of the one or more software applications that are enabled.

8. The method of claim 7, wherein one or more features of the one or more software applications are enabled based on an initial purchase price for the computer hardware unit.

9. The method of claim 7, wherein when one or more features of the one or more software applications are disabled, the method further comprises:
selling one or more additional features of the one or more software applications; and
providing a key to enable one or more features of the one or more software applications that are disabled.

10. The method of claim 7, wherein the one or more integrity verification protocols includes the ARNIC 615 protocol.

11. The method of claim 7 further comprising:
installing one or more updates to the one or more software applications using one or more integrity verification protocols.

12. The method of claim 11, wherein the one or more integrity verification protocols includes the ARNIC 615 protocol.

13. The method of claim 7 further comprising:
verifying a hardware unit is certified for use in an aircraft based on the hardware part number and the software part number.

14. The method of claim 7 further comprising:
interrogating the computer hardware unit to obtain the software part number of one or more of the one or more software applications; and
outputing the software part number of one or more of the one or more software applications.

15. A system for delivering on-aircraft avionics software applications, the system comprising:
means for executing one or more software applications, wherein each software application of the one or more software applications is time and memory space partitioned, wherein each software application of the one or more software applications includes one or more features;
memory means adapted to store the one or more software applications;
means for selectively enabling one or more of the one or more features of the one or more software applications, wherein each software application is adapted with a software part number that identifies the one or more enabled features;
means for delivering software code, wherein the software code includes one or more of a software application, a software upgrade for the one or more software applications, and a software key; and
means for receiving the software code, wherein the means for receiving the software code is adapted to implement one or more integrity verification protocols to verify that the software code is received correctly.

16. The system of claim 15, wherein the means for delivering software code further comprises one or more of a magnetic data storage means, an optical data storage means, a wire based data communications means, and a wireless data communication means.

17. The system of claim 15, further comprising:
means for enabling one or more of the one or more features of the one or more software applications based on the software key.

18. The system of claim 15, further comprising:
means for updating one or more of the one or more software applications based on the software patch for the one or more software applications.

19. The system of claim 15, further comprising:
means for outputting the software part number of one or more of the one or more software applications.

20. The system of claim 15, further comprising:
means for verifying certification of the system in an aircraft based on a hardware part number and the software part number for each of the one or more software applications.
